(19) United States
(12) Patent Application Publication
(10) Pub. No.: US 2009/0199590 A1
(43) Pub. Date: Aug. 13, 2009

(54) METHOD AND APPARATUS FOR COMPRESSING A NATURAL GAS STREAM

(75) Inventors: Robert Adler, Gerasdorf (AT); Helmut Mayer, Rust im Tullnefeld (AT)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/575,958

(22) PCT Filed: Sep. 9, 2005
(86) PCT No.: PCT/EP05/09703

§ 371 Date: Mar. 23, 2007

(30) Foreign Application Priority Data
Sep. 24, 2004 (DE) 10-2004-046-341.7

(51) Int. Cl. F25J 1/02; F17C 13/00

(52) U.S. Cl. 62/614; 62/50.6; 417/901

(57) ABSTRACT

A method and apparatus for compressing a natural gas stream is disclosed. The natural gas stream to be compressed is liquefied and then compressed by means of at least one cryogenic pump. Liquefaction of the natural gas stream to be compressed preferably takes place using the energy from a low-temperature process, specifically in the exchange of heat countercurrent to at least one medium to be heated, preferably countercurrent to a cryogenic medium.

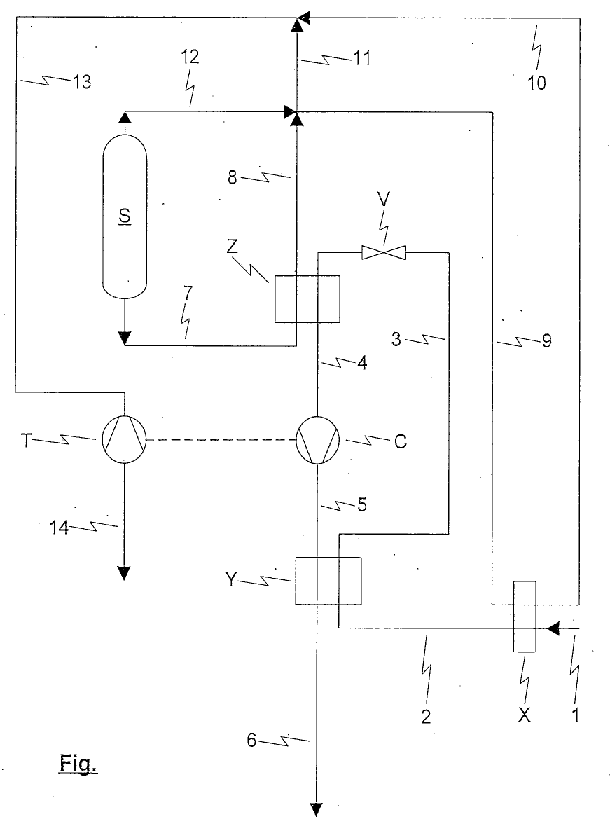

This application claims the priority of International Application No. PCT/EP2005/009703, filed Sep. 9, 2005, and German Patent Document No. 10 2004 046 341.7, filed Sep. 24, 2004, the disclosures of which are expressly incorporated by reference herein.

### BACKGROUND AND SUMMARY OF THE INVENTION

The invention relates to a method and apparatus for compressing a natural gas stream.

Methods for compressing natural gas streams are implemented in particular in natural gas compressing stations such as are necessary at natural gas filling stations. With the methods reckoned among the prior art, the natural gas is compressed by means of two- to five-stage reciprocating piston compressors to a pressure between 250 and 450 bar. The reciprocating piston compressors are driven either directly through electric motors or through hydraulic pumps having electric motors.

Heat is created in the compression of the natural gas, which must be removed through oil, air and/or water radiators. The electrical power input for larger compression installations is 70 KW for a compressor output of 250 m³/h and 800 KW for a compressor output of 4000 m³/h. Providing this power frequently involves a disproportionately high cost. Furthermore, the aforementioned reciprocating piston compressors have the disadvantage that they firstly have a comparatively high sound level —75 dBa and more—and secondly require frequent maintenance work.

It is the object of the present invention to specify a generic method and apparatus for compressing a natural gas stream which requires a significantly lower electrical power input.

In addition, the technology used is to be as low-maintenance and simple as possible in order to permit long service life and low investment costs. Further, it should be possible to be able to remain below the high sound level values mentioned previously.

To achieve the aforementioned object, a method and apparatus for compressing a natural gas stream is provided in which the natural gas stream to be compressed is first liquefied and then compressed by means of at least one cryogenic pump.

The term “cryogenic pump” is understood to mean reciprocating piston pumps, or pressure converters, which can compress cryogenic media. Such reciprocating piston pumps, or pressure converters, require a special design in order to be able to draw in and compress cryogenic media, such as for example, special pressure and suction valves and/or special designs to achieve adequately high NPSH values. These measures are required so that sufficient liquid medium can be drawn in and compressed.

In contrast to the known operating methods, there is no compression of a gaseous natural gas stream but—when using at least one cryogenic pump—compression of a previously liquefied natural gas stream.

In an advantageous manner, the liquefaction of the natural gas stream to be compressed is carried out by using the energy from a low-temperature process.

In what follows, all processes in which energy accumulates in the form of cooling energy should be understood under the term “low-temperature process”. Liquefaction processes for nitrogen, oxygen and argon can be named as examples.

Refining the method and apparatus in accordance with the invention for compressing a natural gas stream, it is provided that the liquefaction of the natural gas stream to be compressed is carried out in a heat exchange countercurrent to at least one medium to be heated, preferably countercurrent to a cryogenic medium to be heated.

The method and apparatus in accordance with the invention for compressing a natural gas stream requires in comparison with traditional methods a far lower electric power input since the energy needed is provided by the low-temperature process, or the (cryogenic) medium to be heated respectively.

Since the liquefied natural gas is compressed by means of one or more cryogenic pumps, almost no compression heat accumulates.

The noise level generation of cryopumps is less than 70 dBa so that no unusual and thus expensive measures for sound insulation are required.

Although cryogenic pumps also require regular maintenance, the maintenance costs are lower than with the aforementioned reciprocating piston compressors. Additionally, cryogenic pumps allow a longer service life than reciprocating piston compressors.

The method and apparatus in accordance with the invention and additional embodiments thereof are explained in more detail in what follows, using the embodiment shown in the drawing.

### BRIEF DESCRIPTION OF THE DRAWING

The drawing illustrates an embodiment of an apparatus for practicing the method of the present invention.

### DETAILED DESCRIPTION OF THE DRAWING

The natural gas stream to be compressed is brought through line 1 in accordance with the invention. This natural gas stream can be taken, for example, from a suitable natural gas pipeline network. Natural gas is usually available in such pipeline networks at a pressure of from 25 mbar up to 60 bar.

The natural gas stream is pre-cooled, or cooled, in the first heat exchanger X to a temperature of approx. −15° C. countercurrent to a nitrogen stream supplied through line 9 to heat exchanger X.

The nitrogen stream used to cool the natural gas originates from a liquid nitrogen storage tank S which serves to store low-temperature liquid nitrogen: the stored nitrogen has a temperature of approx. −150° C. Liquid nitrogen can be drawn from the reservoir through line 7 and gaseous nitrogen through line 12.

The natural gas stream pre-cooled in the first heat exchanger X is taken to a second heat exchanger Y through line 2 and cooled and partially liquefied in same countercurrent to the compressed natural gas stream supplied through line 5 to the second heat exchanger Y which has a temperature of approx. −150° C. The compressed natural gas stream drawn off through line 6 from the second compressor Y has a temperature of approx. −20° C.

The natural gas stream drawn off from the second heat exchanger Y through line 3 is, as mentioned, already available in liquid form for the most part and undergoes constant enthalpy expansion in a restrictor V. Subsequently, complete liquefaction, and if applicable supercooling, of the natural gas stream takes place in the third heat exchanger Z, countercurrent to the liquid nitrogen stream supplied through line 7 to the third heat exchanger.

The now completely liquefied natural gas stream is then taken through line 4 to a cryogenic pump C. Compression to the desired pressure, preferably between 16 and 1000 bar, takes place in this pump. Such cryopumps are in most cases a two-stage design and have an inducer to increase the NPSH value and a high-pressure piston for the actual compression.

Currently, tank pressures up to 250 bar are realized in the compression of natural gas, while pressures up to 1000 bar can already be achieved in the compression of hydrogen. It may be assumed that the upper pressure limit will be moved further upward in the years ahead.

Following this process, the compressed natural gas stream—as already mentioned—is taken through line 5 to heat exchanger Y and heated there to a temperature of about −20° C. The compressed natural gas stream drawn off through line 6 can, as applicable, be heated to approximately ambient temperature in an air heat exchanger not shown in the drawing—to the extent this is necessary or desired.

Dispensing the compressed natural gas stream to natural-gas powered vehicles is accomplished using commercial dispensing or filling devices, not shown in the drawing. The nitrogen stream or streams required for the cooling and liquefaction of the natural gas stream are brought together in lines 11 and 13 and taken to an expander turbine T. The energy released in the expander turbine T is used to drive the cryogenic pump C; represented by the broken line between the expander turbine T and the cryogenic pump C.

The nitrogen stream expanded in the expander turbine T to a pressure between 0 and 16 bar is then removed from the process through line 14 and taken for further use as appropriate, for example as the pressure medium for pneumatic applications (e.g. pneumatic valves).

Filling the storage tank S with cryogenic nitrogen is usually carried out using suitable tanker trucks. Alternatively or in addition, the possibility also exists of generating the nitrogen on site—in what are termed on-site installations—by means of adsorptive, permeative and/or cryogenic methods.

The method and apparatus in accordance with the invention is particularly suitable for use at sites where there are problems with the provision and/or safety of electrical energy. Because no high compression heat accumulates, there are no overheating problems even at sites, or in countries, where extremely high outside temperatures prevail.

1-6. (canceled)

7. A method for compressing a natural gas stream, wherein the natural gas stream to be compressed is liquefied and then compressed by means of at least one cryogenic pump.

8. The method according to claim 7, wherein the liquefaction of the natural gas stream to be compressed is carried out using energy from a low-temperature process.

9. The method according to claim 7, wherein the liquefaction of the natural gas stream to be compressed takes place in an exchange of heat countercurrent to at least one medium to be heated.

10. The method according to claim 9, wherein the medium is a cryogenic medium.

11. The method according to claim 7, wherein the liquefied natural gas stream is compressed to a pressure between 16 and 1000 bar.

12. The method according to claim 7, wherein a medium heated countercurrent to the natural gas stream to be liquefied is expanded and energy gained in the expansion is used to drive the at least one cryogenic pump.

13. The method according to claim 7, wherein the compression of the liquefied natural gas stream takes place in one or more stages.

14. The method according to claim 13, wherein the compression takes place in two stages.

15. A method for compressing a natural gas stream, comprising the steps of:
liquefying the natural gas stream; and
compressing the liquefied natural gas stream by a cryogenic pump.

16. The method according to claim 15, wherein the step of liquefying the natural gas stream includes the step of cooling the natural gas stream in a heat exchanger by a cryogenic medium.

17. The method according to claim 16, wherein the cryogenic medium is nitrogen.

18. The method according to claim 17:
wherein the step of liquefying the natural gas stream includes the step of cooling the natural gas stream in a second heat exchanger by the cryogenic medium;
wherein the cryogenic medium in the heat exchanger is in a gaseous form; and
wherein the cryogenic medium in the second heat exchanger is in a liquid form.

19. The method according to claim 16, further comprising the step of expanding the natural gas stream cooled in the heat exchanger in a restrictor.

20. The method according to claim 18, wherein the step of liquefying the natural gas stream includes the step of cooling the natural gas stream in a third heat exchanger by the compressed liquefied natural stream exiting the cryogenic pump.

21. The method according to claim 16, further comprising the step of driving the cryogenic pump by energy released in an expander turbine by the cryogenic medium after it cools the natural gas stream in the heat exchanger.

22. An apparatus for compressing a natural gas stream, comprising:
a heat exchange system, wherein the natural gas stream is cooled such that the natural gas stream is liquefied; and
a cryogenic pump, wherein the cryogenic pump compresses the liquefied natural gas stream.

23. The apparatus according to claim 22, wherein a cryogenic medium is used in the heat exchange system to cool the natural gas stream.

24. The apparatus according to claim 23, wherein the heat exchange system includes a first heat exchanger and a second heat exchanger, wherein the cryogenic medium in the first heat exchanger is in a gaseous form, and wherein the cryogenic medium in the second heat exchanger is in a liquid form.

25. The apparatus according to claim 22, further comprising a restrictor, wherein the natural gas stream cooled in the heat exchange system is expanded.

26. The apparatus according to claim 22, wherein the heat exchange system includes a heat exchanger and wherein the natural gas stream is cooled by the compressed liquefied natural stream exiting the cryogenic pump.

27. The apparatus according to claim 23, further comprising an expander turbine, wherein the cryogenic pump is driven by energy released in the expander turbine by the cryogenic medium after it cools the natural gas stream in the heat exchange system.
